(19) United States
(12) Patent Application Publication
(10) Pub. No.: US 2010/0153201 A1
(43) Pub. Date: Jun. 17, 2010

(54) SYSTEM AND METHOD FOR PROVIDING FOOD AND GROCERY MULTI-MEDIA CONTENT TO CONSUMERS USING WIDGETS

(76) Inventors: CORBIN DE RUBERTIS, Bainbridge Island, WA (US); Kevin Thomas, Bainbridge Island, WA (US); Jeff Handler, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/334,982

(22) Filed: Dec. 15, 2008

(51) Int. Cl. G06Q 30/00

(52) U.S. Cl. 705/14.19; 705/26

(57) ABSTRACT

A system and method (100) for use by consumers for facilitating the grocery shopping experience for providing food and grocery multimedia content that includes a first computer system (110) for providing an executable software product to a consumer containing program instructions for food recipe selection (203), displaying multimedia advertising content (231), and preparing a shopping list (251). A second computer system (107) uses the executable software product for coordinating selected food recipes (223) with the multimedia content (231) for assisting the consumer in meal preparation.

The present relates generally to web widgets and more particularly to widgets used in connection with content helpful to cooking and grocery consumers.

### BACKGROUND OF THE INVENTION

Many electronic methods for presenting coupons and other shopping advertising, sale coupons, and other content to consumers have been used for many years. Most recently, with the use of personal computers, consumers can find and print coupons directly from their home computer for use in a retail store. One such system for delivering purchasing incentives to consumers through a computer is taught in U.S. Pat. No. 7,233,913, which is incorporated herein by reference. This type of system uses a centralized control along with a communication device at a consumer site. A remote consumer logs in using identity data and geographic region data transmitted by the consumer over a communication network. A plurality of incentive offers are transmitted back to the customer such that the offers are exercisable in the consumer's geographic region. This is followed by the receipt of incentive offer selection data from the consumer over the communication network where the offer selection data includes the designation of a retailer at which selected offer or offers may be exercised.

In response to the consumer selection data, a purchasing incentive is generated containing in encoded form the identity of the retailer designated by the consumer and the identity of the consumer, and transmitting at least one incentive to the consumer over the communication network for subsequent printing by the consumer. Thus, this type of system permits a consumer to plan their shopping and shopping-related activities more efficiently. However, the invention operates by transmitting a list of products available for purchase, receiving consumer selections from the list of products, and then transmitting a shopping list to the consumer. Thus, the consumer may browse through a list or index of available products, preferably organized by store department, and then make selections by marking appropriate entries on a computer screen, such as by positioning a mouse pointer on the desired items and clicking a mouse button.

One problem in using this type of coupon distribution and access by the consumer is that it is subject to fraud. Coupons can be scanned and manipulated so express sales terms are incorrect and/or illegitimate. A response to this can center around proprietary printing technologies so the consumer cannot actually view an image on their computer screen. In order to obtain the coupon, the consumer will have to execute the printing process which allows him or her to create a discrete image of the coupon. This process makes it difficult to prevent emailing the coupon and/or manipulating it for preventing fraudulent transactions.

Still another type of grocery shopping network commonly used involves the use of grocers' retail websites where consumers can browse products and/or plan their shopping experience. Here, the consumers can go online and browse the retail grocery assortment and organize their items into a shopping list that can be delivered to their home or picked up at a retail location.

Finally, a third type of shopping aid utilizes a standalone program for providing data management for recipes and meal planning. These types of programs allow consumers to create a list of their search recipes and prepare meals and menu plans from these lists. One example of this type of aid is a website such as allrecipes.com that uses a repository of searchable recipes for providing suggestions on meal preparation.

### BRIEF DESCRIPTION OF THE DRAWINGS

The accompanying figures refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a system for providing food and multi-media content to consumers using web widgets.

FIG. 2 is flowchart diagram of the system and method for providing food and grocery multi-media content to consumers according to an embodiment of the invention.

FIG. 2A illustrates examples of a screenshot used on a retailer's website that include a widget tab for obtaining the widget for use by the consumer according to an embodiment of the invention.

FIG. 2B illustrates an example of a screenshot that presents recipe ideas for various meals, meal courses, meal venues, or beverages used with the meal according to an embodiment of the invention.

FIG. 2C illustrates examples of various screenshots where the recipe detail may be presented to the consumer according to an embodiment of the invention.

FIG. 2D illustrates an example of a screenshot for a recipe showing the various ingredients that can be printed or sent via email according to an embodiment of the invention.

FIG. 2E illustrates an example of a screenshot for a sample selection screen where the consumer may enter a zip code for determining the nearest store location offering the coupon results presented in a recipe search or coupon search according to an embodiment of the invention.

FIG. 2F illustrates an example of screen showing a typical shopping list generated by the dynamic shopping list feature according to an embodiment of the invention.

FIG. 3 is a flowchart diagram illustrating the process used at the start of the web widget as shown in FIG. 2.

FIG. 4 illustrates a flowchart diagram of the recipe section process illustrated in FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for providing food and grocery multi-media content to consumers. Accordingly, the apparatus, components, and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a”does not, without more constraints, preclude the existence of additional identical elements in the process, method, article, or apparatus that comprises the element.

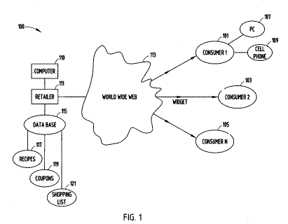

FIG. 1 illustrates a block diagram for a system according to the present invention for providing content to consumers using an executable software product such as a web widget to a consumer. More recently, applications known as “web widgets” have been used in connection with personal computers and mobile devices having web browsing capability. A web widget operates as a portable chunk of code that can be installed and executed within any separate hyper-text mark-up language (HTML) based web page by an end consumer without requiring additional compilation. Web widgets are derived from the idea of code reuse and are also sometimes analogously referred to as a gadget, badge, module, webjit, capsule, snippet, mini, and flake. Web widgets often, but not always, use DHTML, JavaScript, or Adobe Flash programming language. These widgets offer many attractive features working along multiple vectors allowing mass distribution with the capability of being easily dropped on destination sites or utilized as standard advertising units. As seen in FIG. 1, the system 100 includes consumers 101, 103, and 105 that utilize a personal computer 107, cellular telephone 109, or other type of portable device with web browsing capability. A consumer 101, 103, 105 may obtain a widget from a retailer 111 using the Internet and World Wide Web 113. Once installed by the consumer, a computer 110 and database 115 located at the retailer 111 can provide food and grocery media based content to the consumer related to recipes 117, coupons 119, and other media content as well as generating a dynamic shopping list 121 for the consumer to use for shopping either physically or virtually at the retailer's location. Those skilled in the art will recognize that the term “coupon” is used generically throughout meaning both retailer store specials as well as advertising promotions. Therefore, as will be described in further detail herein, the present invention provides consumers with the ability to browse recipes and create shopping lists so that ingredients and other special products, relevant to the recipe, are presented to the consumer from the specific grocer or retailer. This offers a great advantage to the consumers, allowing them to obtain products that are currently in-stock and available at a store location. This is in contrast to sites that offer generic ingredients to the consumer who has no idea as to products available or where they might be obtained. Accordingly, the present invention allows consumers to also determine items for sale, times of sale, relevant manufacturer coupon discounts for an appropriate time period, as well as the ability to create a shopping list and menu plan with self-printed coupons attached before traveling to the grocery or retail store location.

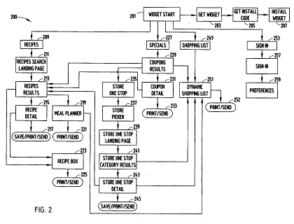

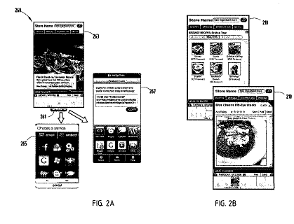

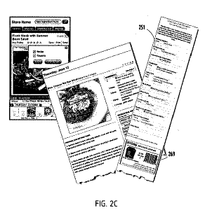

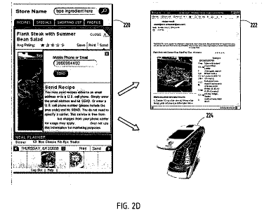

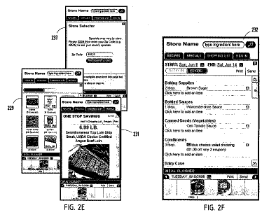

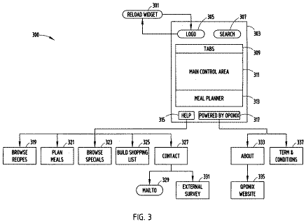

With reference to FIG. 2 and FIGS. 2A-2F, FIG. 2 illustrates a flowchart diagram of a method for providing shopping information and other content to consumers using an executable software product such as software code used in connection with a computer system like a web widget or the like. As will be evidnet to those skilled in the art, in computing, an executable file causes a computer to perform indicated tasks according to encoded instructions. The process 200 begins a widget start 201 where the consumer obtains a widget 203 through the Internet. Once the widget is located, an appropriate install code 205 is obtained where the widget can be installed on the consumer's personal computer 207. Although a widget can be installed on a personal computer, it is usually installed on personal portals, social networking sites, web blogs, or other locations that reside “in the web.” Thus, the widget code is advantageous to the consumer since it is transportable and can be embedded in various contexts that are directly accessible by shoppers or other consumers. In use, a consumer may access a retailer or store owner's website, which will provide a location for the web widget to be accessed. FIG. 2A illustrates examples of various screens used on a retailer's website 260, that includes widget tab 261 for obtaining a widget. The widget tab on the widget screen and the widget's distribution methods are proved by a third party such as WidgetBox, Inc., Clearspring, Inc. or the like. An initial screen might include any type of notice, welcome, and/or advertisement 263 offering the consumer the ability to access a widget used in combination with the retailer's business. Once actuating the widget tab 261, the consumer may be prompted with an install screen 265 as used with a portable device and/or a prompt screen 267 for allowing the consumer to copy the widget code making it easily transportable for use with their personal computer's web browser.

Referring again to FIG. 2, after installation is complete, one feature of the invention after widget start 201 is providing assistance and ideas in selecting a meal recipe 209. FIG. 2B illustrates an example of a screenshot that presents recipe ideas 208 for various meals, meal courses, meal venues, or beverages used with the meal. A screen shot showing recipe details 210 may be further selected by the consumer. As seen in FIG. 2, the process for locating a recipe allows the consumer to utilize a recipe search page 211 that may yield the appropriate recipe results 213. The details of each recipe 215 are then presented and/or displayed to the consumer, where the recipe details can be saved, printed, electronically emailed to other persons 217, and/or presented to a meal planner 219 where they can later be displayed, printed and/or sent to other persons 221. FIG. 2E illustrates examples of various screenshots where the recipe detail 215 may be presented to the consumer. The consumer may select various preparation instructions or other presentation formats for later use in meal plan and/or preparation.

The details of each recipe 215 are also presented to a meal planner 219. The meal planner may be a calendar or other aid in helping the consumer prepare daily, weekly, or monthly meals.

The meal planner 219 operates by appending the ingredients of the recipe to a dynamic shopping list. For example, if a beef bourguignon recipe were to include a bottle of wine, chuck steak, carrots, celery, and onions, all these ingredients can be added to the meal planner 219 as well as a dynamic shopping list 251. The recipe results 213 as well as any recipe detail 215 are stored in a memory such as recipe box 223 where they can later be displayed, printed and/or sent to other persons 225. As seen in FIG. 2D, this recipe 220 may be printed showing the various ingredients or sent via text message or email to other shoppers 222, 224.

After the widget start 201, the consumer may also select any special products offerings or “specials” 227 offered by a particular grocer or retailer. After selecting a special tab 227 in the widget, coupons or other offers can be presented to the consumer 229 that may correspond with the recipe results 213 or may be input to the consumer's dynamic shopping list 251. The details on the coupon offer 231 are then presented both to the consumer as well combining it with the recipe results 213 and dynamic shopping list 251. These coupons can be later be displayed, printed and/or emailed to other consumers 233. FIG. 2C also illustrates a discount coupon 269 shown combined with the results of the dynamic shopping list 251.

In situations where the consumer wishes to select a specific store in which to shop, after being presented with the coupon results 229, the consumer may enter a screen where he or she might select or be recommended a store 235. This will forward the consumer to a store selection screen 237 where the consumer will be presented with choices where the consumer might input data for selecting a specific store. FIG. 2E illustrates an example of a sample selection screen where the consumer may enter their zip code for determining the nearest store location offering the coupon results 229 that were presented. This selection screen can direct the consumer to a store landing page 239, where the consumer is presented with offers or discounts offered by that specific store 241 as well as store one stop shopping details 243. These category results are also presented to the dynamic shopping list 251. Thereafter, additional screens may be used to further specify details about the coupons offered by that specific store. The consumer may then determine they wish to display, save, print and/or send these coupon details via text message or email 245.

After widget start 201, the consumer may also select to move directly to a shopping list 249. Selection of a shopping list tab will direct the consumer to a dynamic shopping list screen 251 that illustrates ingredients needed for various recipes that are input to the meal planner 219. The coupon results 229 or coupon details 231 can then be selected for review by the consumer. FIG. 2F illustrates an example of a screen showing a typical shopping list 232 generated by the dynamic shopping list 251. The dynamic shopping list 251 can also be edited by the consumer to add or delete items not associated with recipes or specials. Thereafter, the consumer may elect to either save, print, text message, or email this list on to other shoppers interested in these items 252.

Finally, after widget start 201, the consumer may also select to enter a consumer sign-in section 253. This directs the consumer to a sign-in screen 257 where he or she may select various preferences 259 to enhance the consumer's shopping experience. In the preferences section 259, a consumer profile may be maintained in the application that may be authenticated against a store or retailer's home customer database. This allows the store or retailer to identify the consumer with a surname/user name and password combination. Consumer data may include such variables as dietary or recipe preferences that are tailored to the consumer's lifestyle. This section may also facilitate uploading by the consumer of preferred recipes that may be shared with others, a health profile for coordinating various recipes to the consumer's dietary requirements, and/or other legal terms and conditions that are specified by the grocer or retailer.

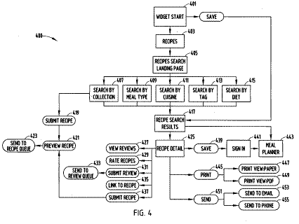

FIG. 3 is a flowchart diagram illustrating the process used at the start of the web widget 300 as shown in FIG. 2. Upon startup, the widget 303 may be loaded and/or reloaded 301 and provides both enunciation and functionality to the consumer, such as a logo 305, search 307, tab identifiers 309, main content area 311, meal planner 313, a help section 315, and an ownership notice 317. The help section 315 includes such items as the ability to browse recipes 319, plan meals 321, browse specials 323, build shopping lists 325, as well as provide contact information 327. The contact information may include either email and address information 329 or the ability to offer external surveys 331 for use to improve the consumer's shopping experience. The ownership notice 317 may include such items as an “about” tab 323 for providing information about the owner of the widget or details regarding the owner's website 335. Legal terms and conditions 337 may also be provided at this location.

FIG. 4 illustrates a flowchart diagram of the recipe section 209 illustrated in FIG. 2. The recipe process begins at widget start 401 where the recipe tab is selected 403. This, in turn, directs the consumer to a specific recipe search page 405. The search feature allows the consumer to search by either collection 407, meal type 409, cuisine 411, search tag 413, or by specific diet 415. After one or more of these individual searches, the search results 417 are input to a meal planner 443. In the event searches are made by collection 407, recipes may also be submitted by the consumer 419 where they can be previewed 421 and sent at some later time to a recipe queue 423.

The consumer may also elect to review recipes in detail 425 such as specific details of a recipe review 427, a recipe rating 429, submitted recipe reviews by others 431, recipe links 435 and/or other types of recipe submissions 437. Any reviews submitted regarding the recipe 431 may be sent to a database or “queue” for a review 433 at some later time. Additionally, any submitted recipes 437 will also be sent to a database location where the recipe can be previewed 421 and forwarded to the recipe queue 423. The recipe details 425 may also be saved 439, where the consumer may sign-in 441 and submit details of the recipe to the meal planner 443. The recipe details may also be printed in a paper copy 447 or saved electronically 449 in an image file format or the like. Finally, the recipe may also be electronically sent 451 using email 453, by facsimile 455, or other electronic means.

The present invention is directed to a web widget for allowing the consumer to easily search and plan recipes, review store coupons, advertisements and specials, as well as to generate a dynamic shopping list that can be used at the grocer or retailer. Thus, the present invention provides a useful tool that not only helps consumers, but also allows manufacturers and retailers to put their brands and content into context depending on consumer needs and requests. Also, the invention allows a replacement for a grocer's weekly circular reducing the reliance and expense associated with newspaper advertising.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A system for use with consumers for facilitating the grocery shopping experience for providing food and grocery multimedia content comprising:
a first computer system for providing an executable software product to a consumer containing program instructions for food recipe selection, displaying multimedia advertising content, and preparing a shopping list; and
a second computer system using the executable software product for coordinating selected food recipes with the multimedia content for assisting the consumer in meal preparation.

2. A system for use with consumers as in claim 1, wherein the executable software product is a web widget.

3. A system for use with consumers as in claim 1, wherein the multimedia advertising content are coupons for offering discount products.

4. A system for use with consumer as in claim 1, wherein the food recipe selection is searchable by the consumer based on selectable consumer-based parameters.

5. A system for use with a consumer as in claim 1, wherein the executable software product includes a meal planner for allowing the consumer to plan at least one meal based upon a calendar date.

6. A system for use with a consumer as in claim 1, wherein the executable software product includes functionality for storing favorite recipes identified by the consumer on an external database.

7. A system for use with a consumer as in claim 1, wherein the executable software product includes functionality for identifying a preferred retail store based on consumer location.

8. A system for use with a consumer as in claim 1, wherein the executable software product includes the functionality for printing store coupons at the consumer location based upon recipe selection.

9. A system for use with a consumer as in claim 1, wherein the shopping list is dynamically adjusted based on both food recipe selection and multimedia content offered by a retailer.

10. A widget for use with at least one computer associated with at least one grocery retailer, the widget comprising:
embeddable code for dynamically selecting food recipes, displaying multimedia content, and creating shopping lists using the computer, the widget providing input to a retailer and receiving at least a portion of the multimedia content from the retailer for coordinating selected food recipes with the multimedia content to assist the consumer in meal preparation.

11. A widget associated with at least one grocery retailer as in claim 10, wherein the executable software product is usable in connection with a web browser.

12. A widget associated with at least one grocery retailer as in claim 10, wherein the multimedia advertising content are coupons for offering discounted products at the grocery retailer.

13. A widget associated with at least one grocery retailer as in claim 12, wherein the shopping list is dynamically adjusted based on both food recipe selection and multimedia content offered by the grocery retailer.

14. A widget associated with at least one grocery retailer as in claim 10, wherein food recipes are searchable based on selectable consumer-based parameters.

15. A widget associated with at least one grocery retailer as in claim 14, wherein the consumer-based parameters are based on at least one from the group of recipe collections, recipe meal type, recipe cuisine, recipe tag, or recipe diet.

16. A widget associated with at least one grocery retailer as in claim 10, wherein the executable software product includes a meal planner for allowing the consumer to plan at least one meal based upon a calendar date.

17. A widget associated with at least one grocery retailer as in claim 10, wherein the widget includes functionality for storing favorite recipes identified by the consumer on an external database.

18. A widget associated with at least one grocery retailer as in claim 10, wherein the executable software product includes functionality for identifying a preferred retail store based on consumer location.

19. A widget associated with at least one grocery retailer as in claim 10, wherein the widget includes the functionality for printing store coupons at the consumer location based upon recipe selection.

20. A method for use with an executable software product stored on a computer-readable medium containing program instructions for providing a widget for use with a computer, the program instructions providing input to a retailer for providing searchable recipes, discount coupons, and shopping lists to a consumer comprising the steps of:
providing a searchable food recipe database at the retailer for locating recipes based in predefined search criteria viewable though the executable software product;
providing a searchable database of coupon discounts provided by the retailer viewable though the executable software product; and
creating a shopping list based upon selected recipe and coupon discounts viewable though the executable software product.

21. A method for use with an executable software product as in claim 20, further comprising the step of:
formatting the executable software product into a web widget.

22. A method for use with an executable software product as in claim 20, further comprising the step of:
providing store discount coupons from the multimedia advertising.

23. A method for use with an executable software product as in claim 20, further comprising the step of:
searching the food recipe database based upon at least one from the group of: recipe collection, recipe meal type, recipe cuisine, recipe tag, and recipe diet.

24. A method for use with an executable software product as in claim 20, further comprising the step of:
providing a meal planner used in connection with the executable software product for allowing the consumer to plan at least one meal based upon a calendar date.

25. A method for use with an executable software product as in claim 20, further comprising the step of:
providing functionality in the executable software product for storing favorite recipes identified by the consumer on an external database.

26. A method for use with an executable software product as in claim 20, further comprising the step of:
providing functionality in the executable software product for identifying a preferred retail store based on consumer location.

27. A method for use with an executable software product as in claim 20, further comprising the step of:
providing functionality in the executable software product for printing store coupons at the consumer location based upon recipe selection.

28. A method for use with an executable software product as in claim 20, further comprising the step of:
dynamically adjusting the shopping list based on both food recipe selection and coupon discounts offered by a retailer.
